(19) United States
(12) Patent Application Publication
(10) Pub. No.: US 2025/0155223 A1
(43) Pub. Date: May 15, 2025

(54) METHOD FOR SIMULATING WEAPON EFFECT AGAINST A SPECIFIC TARGET

(71) Applicant: BAE SYSTEMS BOFORS AB, SE-69180 Karlskoga (SE)

(72) Inventors: Frans ERIKSSON, HAMMARÖ (SE); Erik JONASSON, Väse (SE)

(73) Assignee: BAE SYSTEMS BOFORS AB, SE-69180 Karlskoga (SE)

(21) Appl. No.: 18/840,121

(22) PCT Filed: Feb. 6, 2023
(86) PCT No.: PCT/SE2023/050100

§ 371 Date: Aug. 21, 2024

(30) Foreign Application Priority Data
Mar. 15, 2022 (SE) 2200031-9

(51) Int. Cl. F41G 3/26; G06T 17/00

(52) U.S. Cl. CPC F41G 3/2633; G06T 17/00

(57) ABSTRACT

A method for simulating weapon effect against a specific target includes at least one model of a warhead where the model of the warhead is adapted so that the weapon effect of the warhead is simulated as a volume. A method for simulating weapon effect against a specific target including at least one model of a warhead and a computer program product is also provided.

### BACKGROUND

### Background and Summary

The present invention relates to a method for simulating weapon effect against a specific target comprising at least one model of a warhead and where the model of the warhead is adapted so that the weapon effect of the warhead is simulated as a volume.

Modelling of performance of a weapon system is of great importance in a wide variety of tasks such as to develop doctrines such as tactical doctrines, to learn more about a system for further research and development efforts, to evaluate a systems performance for a specific target or in a specific situation, and to train users of the specific system.

According to one traditional method, the task of evaluating the effectiveness of a weapon system in a combat engagement is performed using a two-step approach. The first step is to create an error budget for the system being analyzed, and the second step is to use that error budget to evaluate the probability of defeating a target.

An error budget is a collection of forces and effects that contribute to a fired round missing its intended aim point. These forces and effects are described through equations that calculate their downrange miss distances. The values of the results are then root-sum-squared into three categories based on how the errors manifest themselves in a scenario. These categories are round-to-round, burst-to-burst, and engagement-to-engagement. These values are then used in further analysis.

Once an error budget has been created, it is used with one of two methodologies to calculate the probability of defeating a target. The method used to analyze the weapon depends on the complexity of the firing situation. One method is a statistical approach that is used in direct fire situations with simple targets. The other method is an iterative solution that is used in more complex scenario or with air burst munitions.

An example of a system and method for evaluating the performance of a weapon platform is described in patent application U.S. Pat. No. 9,830,408 B1. A drawback with currently existing solutions according to 9,830,408 B1 is that the described system and method does no discloses that the weapon effect is simulated as a volume. The patent application neither discloses a closed-loop system.

Further problems which the present invention aims to solve will be elucidated below in the detailed description of the various embodiments.

The invention relates, according to an aspect thereof, to a method for simulating weapon effect against a specific target comprising at least one model of a warhead where the model of the warhead is adapted so that the weapon effect of the warhead is simulated as a volume.

According to further aspects of the improved method for simulating weapon effect against a specific target;
the weapon effect is shown as burst points arranged in a three dimensional matrix.
a three dimensional model of the target is provided.
an estimate of a combat success rate of the specific target with a specific warhead is calculated.

The method further comprises comprising at least;
one model of a sight unit,
one model of a fire control unit,
one model of a launch unit,
one model of a projectile trajectory unit arranged with a model of a warhead unit, collectively arranged to calculate the estimate of combat success rate of the specific target.

According to further embodiments of the invention the invention also comprises a computer program product wherein the method for simulating weapon effect against a specific target comprises at least one model of a warhead implemented in program code.

Advantages of the present invention includes that the simulation is performed in three dimensions compared to the conventional two dimensions. The actual performance of a warhead is dependent upon when the warhead is initiated. Depending upon the actual situation the warhead could approach the target perpendicular to the target or parallel to the target and all the alternatives between a full perpendicular approach and a fully parallel approach. Depending upon the simulated approach and the simulated initiation of the warhead it is of great importance if the simulated weapon effect is calculated in a plane of in a volume wherein simulation in a volume is considerable more realistic than a simulation of weapons effect in a plane.

### BRIEF DESCRIPTION OF THE DRAWINGS

The invention will be described in greater detail below with reference to the attached figures, in which:

FIG. 1 shows a block diagram of a closed loop weapon system evaluation method according to one embodiment of the invention.

FIG. 2 shows the distribution of burst points for a warhead in a volume according to one embodiment of the invention.

FIG. 3a shows the distribution of burst points for a warhead in a volume for a first plane according to one embodiment of the invention.

FIG. 3b shows the distribution of burst points for a warhead in a volume for a second plane according to one embodiment of the invention.

FIG. 3c shows the distribution of burst points for a warhead in a volume for a third plane according to one embodiment of the invention.

FIG. 3d shows the distribution of burst points for a warhead in a volume for a fourth plane according to one embodiment of the invention.

FIG. 3e shows the distribution of burst points for a warhead in a volume for a fifth plane according to one embodiment of the invention.

### DETAILED DESCRIPTION

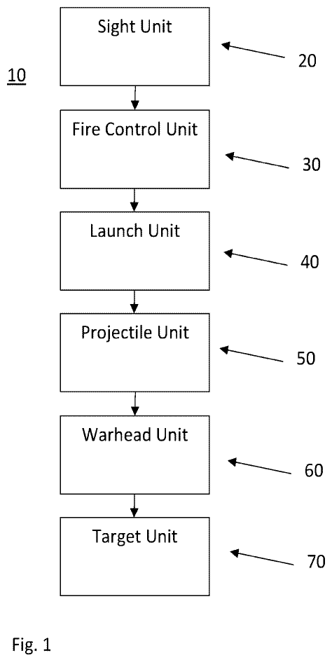

FIG. 1 shows a block diagram of a closed loop weapon system evaluation method 10 according to one embodiment of the invention. The closed loop weapon system evaluation method 10 comprises a number of modules describing the weapon system. The modules of the closed loop weapon system evaluation method 10 could include, but is not limited to, the following modules; a sight unit 20, a fire control unit 30, a launch unit 40, a projectile trajectory unit 50, a warhead unit 50 of said projectile unit, a target unit 60. The closed loop weapon system evaluation method 10 is collectively arranged in a data processing system such as a computer or other calculating unit arranged to carry out sequences of arithmetic or logical operations automatically via computer programming.

The sight unit 20 represent a model of a sight of weapon system such as a gun. The sight unit 20 comprises models of radar sensors, models of electro optical sensor/sight, and/or a model of a laser rangefinder.

The fire control unit 30 represent a model of a fire control system of a weapon system comprising at least one of a model of a ballistic calculator, weather models, model of prediction filters, models of ship gyro for specific modelling for ship mount systems.

The sight unit 20 and the fire control unit 30 could also be modelled as a combined entity.

The launch unit 40 represent a model of a launch unit, such as a gun. The launch unit is used for launching a projectile from the launch unit. In the case the launch unit is a gun the components of the gun could include models for an initiator, a propellant, a projectile and a barrel. At ignition the propellant is ignited and burned to generate gas and a gas pressure acting upon the projectile arranged in the barrel. When the pressure achieves a certain threshold the projectile starts to move in the barrel. The propellant continuous to generate gas acting upon the projectile until the projectile leaves the gun barrel. The launch unit 40 could also comprise models of traverse speed and limitations, elevation speed and limitations, rate of fire, dispersion etc.

The projectile trajectory unit 50 comprises a model of a projectile trajectory comprising ballistic models adapted for different projectile characteristics.

The warhead unit 60 comprises a model of the warhead of the projectile. The dynamic, or transit dynamic, properties of a warhead could be calculated in a finite element program such as LS-Dyna. The results from a transit dynamic calculation, or from other simulation, are represented in the warhead unit 60 by a model comprising at least one model representing at least one of fragmentation velocity, fragmentation size, fragmentation shape, fragmentation trajectory, and fragmentation ballistics and/or other additional models/representation regarding the fragments physical performance. Further the projectile could be modelled with regards to muzzle velocity, rotational velocity, Cd coefficient (drag coefficient) and/or other additional models regarding the projectiles physical performance.

Further the fuze of the ammunition could be modelled with parameters for a time fuze such as time dispersion, auto destruct functionality and function probability of time fuze, and/or other additional models regarding the performance of the time fuze. Further the fuze could be modelled with parameters for a point detonation fuze such as point detonation delay, point detonation target hardness requirement, point detonation function probability for a point detonation fuze, and/or other additional models regarding the performance of the point detonation fuze. Further the fuze could be modelled with parameters for a proximity fuze such as detection area radius and shape for a proximity fuze, probability of fuze trigg within detection area for a proximity fuze, dispersion of burstpoints within detection area for a proximity fuze and overall probability of fuze function for a proximity fuze, and/or other additional models regarding the performance of the proximity fuze.

The target unit could comprise models for path, speed, geometry, materials and vital components/Sensitive section of the target and/or other additional models regarding the performance and/or construction of the target.

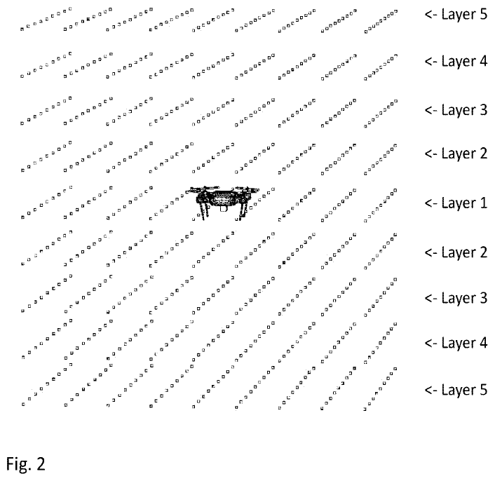

FIG. 2 shows distribution of burst points for a warhead in a volume, i.e. a three dimensional distribution. Shown in the figure are simulation positions for a 9×9×9 matrix wherein each simulation point represents a point of potential detonation, i.e. a burst point. The distances between the points, i.e. the distance in x, y and z dimension, could be adapted depending upon the specific warhead, target and/or other parameters relevant for the simulation. In the shown embodiment the distances in the three dimensions are identical why the simulation space is represented as a cube comprising 9×9×9=729 simulation positions. The number simulation point could also be adapted depending upon the specific warhead, target and/or other parameters relevant for the simulation.

The projectile moves from left to right in the figures and the target moves from right to left. In a simulation it is possible to set the speed of the projectile and/or the target and in an example the speed of the projectile could be in the range of 550 m/s to 650 m/s and the rotation of the projectile could be in the range 3800 rad/s to 4600 rad/s and the speed of the target could be in the range 10 m/s to 30 m/s. I is also possible to adapt the grid and in the specific shown example the burst point distance is 0.5 m, and the number of grid points is a three dimensional cube with 9 grid points (9×9×9).

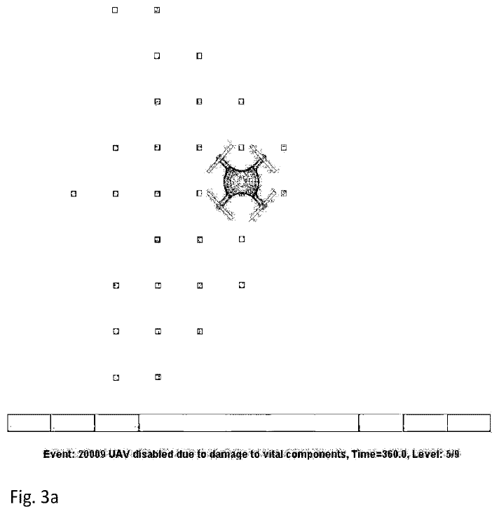

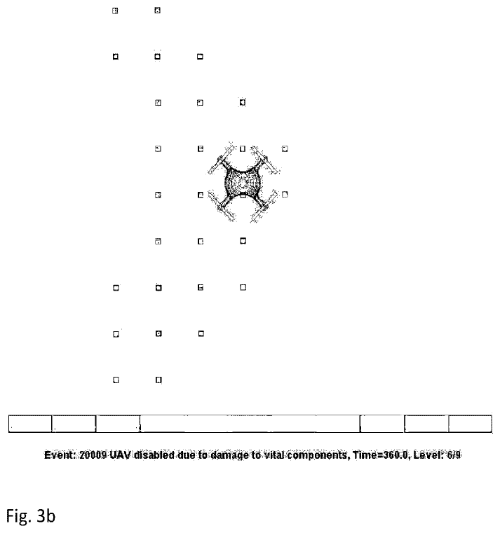

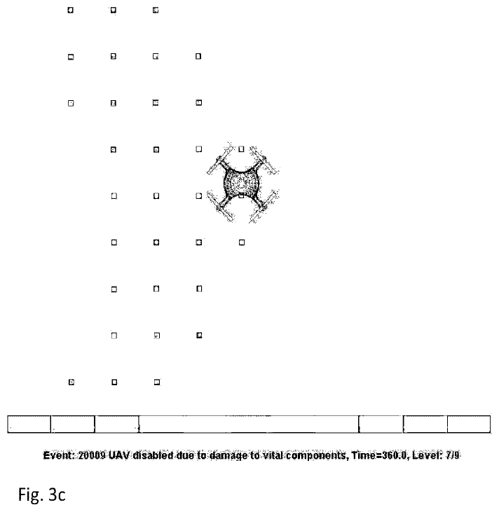

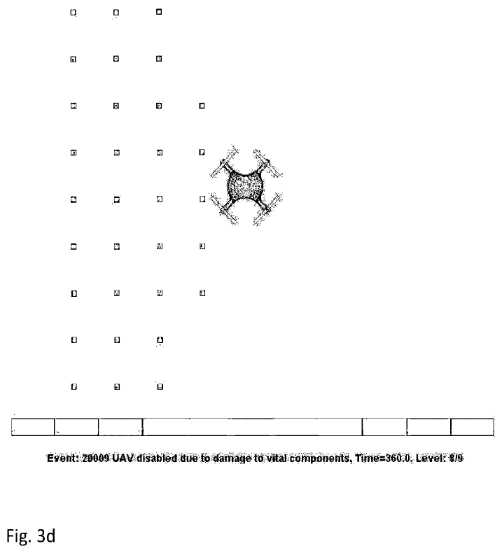

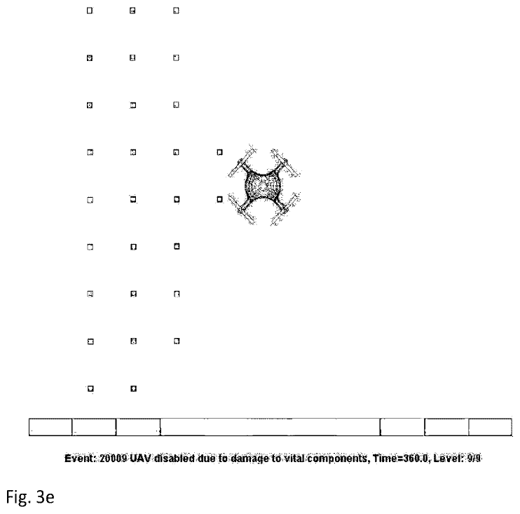

FIG. 3a shows distribution of burst points for a warhead in a volume, a three dimensional distribution, shown for a first plane, i.e. shown in two dimensions. The shown points relates to burst points wherein the warhead should be initiated to successfully, with a certain probability, reach a weapon effect in the target, where the target is shown as an UAV in this specific example. The first plane represent a plane wherein the warhead is arranged in the same plane as the target, i.e. the warhead is colliding with the target.

FIG. 3b shows distribution of burst points for a warhead in a volume, a three dimensional distribution, shown for a second plane. For the simulated warhead the weapon effect is fully symmetrical why the second plane comprises two identical mirrored planes arranged with a predefined and adjustable distance from the first plane. The shown points relates to burst points wherein the warhead should be initiated to successfully, with a certain probability, reach a weapon effect in the target, where the target is shown as an UAV in this specific example.

FIG. 3c shows distribution of burst points for a warhead in a volume, a three dimensional distribution, shown for a third plane. For the simulated warhead the weapon effect is fully symmetrical why the third plane comprises two identical mirrored planes arranged with a predefined and adjustable distance from the second plane.

FIG. 3d shows distribution of burst points for a warhead in a volume, a three dimensional distribution, shown for a fourth plane. For the simulated warhead the weapon effect is fully symmetrical why the fourth plane comprises two identical mirrored planes arranged with a predefined and adjustable distance from the third plane.

FIG. 3d shows distribution of burst points for a warhead in a volume, a three dimensional distribution, shown for a fifth plane. For the simulated warhead the weapon effect is fully symmetrical why the fifth plane comprises two identical mirrored planes arranged with a predefined and adjustable distance from the fourth plane.

If the planes shown in FIGS. 3a, 3b, 3c, 3d and 3e are combined the result is a visualization of the burst point in three dimensions, i.e. in a volume.

The invention is not limited to the embodiments specifically shown, but can be varied in different ways within the scope of the patent claims.

It will be appreciated, for example, that the modules of the closed loop weapon system evaluation method could be varied and how the modules are arranged, as well as the integral modules and implementation, is adapted to the needs of the user and/or customer of a closed loop weapon system evaluation method. The closed loop weapon system evaluation method could also be changed depending upon other current design characteristics.

Embodiments of the present invention can take the form of an entirely hardware embodiment or an embodiment containing both hardware and software elements. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The medium could also be a service arranged to an electronic communication means such as Internet or a cloud service.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

1. A method for simulating weapon effect against a specific target comprising at least one model of a warhead, comprising
adapting the model of the warhead so that the weapon effect of the warhead is simulated as a three dimensional volume,
providing a three dimensional model of the target, and
showing the weapon effect as burst points arranged in a three dimensional matrix.

2. The method for simulating weapon effect against a specific target according to claim 1, comprising calculating an estimate of a combat success rate of the specific target with a specific warhead.

3. The method for simulating weapon effect against a specific target according to claim 2, wherein the method comprises at least;
one model of a sight unit,
one model of a fire control unit,
one model of a launch unit, and
one model of a projectile trajectory unit arranged with a model of a warhead unit,
the method comprising collectively the at least one model of a sight unit, one model of a fire control unit, one model of a launch unit, and one model of a projectile trajectory unit to calculate the estimate of combat success rate of the specific target.

4. A computer program product wherein the method according to claim 1 is implemented in program code.

5. A method for simulating weapon effect against a specific target comprising at least one model of a warhead wherein the model of the warhead is adapted so that the weapon effect of the warhead is simulated as a three dimensional volume and where a three dimensional model of the target is provided and where the weapon effect is shown as burst points arranged in a three dimensional matrix.

6. The method for simulating weapon effect against a specific target according to claim 5, comprising calculating an estimate of a combat success rate of the specific target with a specific warhead.

7. The method for simulating weapon effect against a specific target according to claim 6, wherein the method comprises at least
one model of a sight unit,
one model of a fire control unit,
one model of a launch unit, and
one model of a projectile trajectory unit arranged with a model of a warhead unit,
the method comprising collectively the at least one model of a sight unit, one model of a fire control unit, one model of a launch unit, and one model of a projectile trajectory unit to calculate the estimate of combat success rate of the specific target.

8. A computer program product wherein the method according to claim 5 is implemented in program code.
